(19) United States
(12) Patent Application Publication
(10) Pub. No.: US 2007/0256020 A1
(43) Pub. Date: Nov. 1, 2007

(54) Information processing apparatus, method for controlling information processing apparatus and recording medium

(75) Inventor: Tatsuyoshi Haga, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Tokyo (JP)

(21) Appl. No.: 11/706,292

(22) Filed: Feb. 15, 2007

(30) Foreign Application Priority Data
Apr. 27, 2006 (JP) 2006-123937

(51) Int. Cl. G06F 3/00

(52) U.S. Cl. 715/741

(57) ABSTRACT

Disclosed herein is An information processing apparatus, including: a control unit for receiving operation requests from a plurality of users, for acquiring user information regarding the users who perform the operation requests, for permitting an operation input from one user among the plurality of users who perform the operation requests, and for inhibiting the operation inputs from the other users; and a notification unit for outputting notification information for notifying the other users inhibited from the operation inputs, of the user information regarding the one user who is permitted to perform the operation input.

### BACKGROUND OF THE INVENTION

1. Field of the Invention

The present invention relates to an information processing apparatus in which operation inputs can be performed by a plurality of users, a method for controlling the information processing apparatus, and a recording medium.

2. Description of Related Art

In recent years, a system which can remotely operate an information processing apparatus, such as a copier and a printer, connected through a network to a user terminal operated by a user, has been developed (for example, refer to JP-Tokukai-2005-321944A and JP-Tokukai-2000-357072A) . In the cases, there have been disclosed a method in which the same screen as an operation screen displayed on the information processing apparatus is displayed on a user terminal (for example, refer to JP-Tokukai-2002-281195A), a method for sending information regarding a position operated on the operation screen from the user terminal to the information processing apparatus side, and determining the operated position on the information processing apparatus side to determine which operation has been performed (for example, refer to JP-Tokukai-H05-122424A), and the like. By displaying the same screen, consistency in operation inputs can be achieved between the information processing apparatus side and the user terminal side. Moreover, since the same screen image is always provided to the user, it becomes easy for the user to perform each operation input.

In an environment where the remote operations are possible, it is possible for a plurality of the users to simultaneously perform the remote operations. Hence, in order to prevent occurrences of operational contradiction and confusion owing to the simultaneous operations of the respective users, it is necessary to perform an exclusive control for inhibiting the operation inputs from the other users while one user is performing the operation input.

However, if the exclusive control is only performed, the users inhibited from the operation inputs can never grasp a usage situation of the information processing apparatus, for example, the users cannot know who performs the operation input right now, or until when the users must wait. As a result, although the operation of the information processing apparatus by the one user is ended, the other users inhibited from the operation inputs take actions, for example, try the operation inputs again after a while. Therefore, the usage efficiency of the information processing apparatus was deteriorated.

On the contrary, the user permitted to perform the operation input cannot grasp the presence of the other standby users. Accordingly, there has been a problem that the user occupies the information processing apparatus for a long time.

### SUMMARY

It is an object of the present invention to enhance the usage efficiency of the information processing apparatus under an environment in which the exclusive control is performed.

In order to achieve the foregoing object, according to a first aspect of the present invention, an information processing apparatus comprises:

a control unit for receiving operation requests from a plurality of users, for acquiring user information regarding the users who perform the operation requests, for permitting an operation input from one user among the plurality of users who perform the operation requests, and for inhibiting the operation inputs from the other users; and

a notification unit for outputting notification information for notifying the other users inhibited from the operation inputs, of the user information regarding the one user who is permitted to perform the operation input.

Moreover, according to a second aspect of the present invention, an information processing apparatus comprises:

a control unit for receiving operation requests from a plurality of users, for permitting an operation input from one user among the plurality of users whose operation requests are received, and for inhibiting the operation input from the other users; and

a notification unit for outputting notification information for notifying the one user permitted to perform the operation input, of presence of the other users inhibited from the operation input.

Moreover, according to a third aspect of the present invention, a method for controlling an information processing apparatus, comprises:

receiving operation requests to the information processing apparatus from a plurality of users, and acquiring user information regarding the users who perform the operation requests;

permitting an operation input from one user among the plurality of users who perform the operation requests, and inhibiting the operation inputs from the other users; and

outputting notification information for notifying the other users inhibited from the operation inputs, of the user information regarding the one user who is permitted to perform the operation input.

Moreover, according to a fourth aspect of the present invention, a method for controlling an information processing apparatus, comprises:

receiving operation requests to the information processing apparatus from a plurality of users;

permitting an operation input from one user among the plurality of users whose operation requests are received, and inhibiting the operation input from the other users; and

outputting notification information for notifying the one user permitted to perform the operation input, of presence of the other users inhibited from the operation input.

Moreover, according to a fifth aspect of the present invention, a computer-readable recording medium recording a program for allowing a computer that controls an information processing apparatus to execute:

receiving operation requests from a plurality of users, and acquiring user information regarding the users who perform the operation requests;

permitting an operation input from one user among the plurality of users who perform the operation requests, and inhibiting the operation inputs from the other users; and

outputting notification information for notifying the other users inhibited from the operation inputs, of the user information regarding the one user who is permitted to perform the operation input.

Moreover, according to a sixth aspect of the present invention, a computer-readable recording medium recording a program for allowing a computer that controls an information processing apparatus to execute:

receiving operation requests to the information processing apparatus from a plurality of users;

permitting an operation input from one user among the plurality of users whose operation requests are received, and inhibiting the operation input from the other users; and

outputting notification information for notifying the one user permitted to perform the operation input, of presence of the other users inhibited from the operation input.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a view showing an output system including a multi-functional peripheral (MFP) as an information processing apparatus of the present invention;

FIG. 2 is a diagram showing an internal construction of a user terminal of FIG. 1;

FIG. 3 is a diagram showing an internal construction of the MFP of FIG. 1;

FIG. 4 is a flowchart explaining remote control processing executed by the MFP;

FIG. 5 is a view showing an example of a management table for use in the MFP;

FIG. 6A is a view showing an example of an operation screen displayed on a main operation unit of the MFP;

FIG. 6B is a view showing an example of an operation screen page for a remote control, which is displayed on the user terminal;

FIG. 7A is a view showing an example of a notification screen page to an operating user;

FIG. 7B is a view showing an example of a notification screen page to a standby user;

FIG. 8 is a view showing an example of a notification screen on the main operation unit of the MFP;

FIG. 9 is a flowchart explaining reservation control processing executed by the MFP;

FIG. 10 is a view showing an example of a management table for use in a second embodiment;

FIG. 11A is a view showing an example of a notification screen page for the operating user;

FIG. 11B is a view showing an example of a notification screen page to a reservation standby user;

FIG. 12 is a view showing an example of a notification screen page to a login user; and

FIG. 13 is a view showing an example of the notification screen on the main operation unit of the MFP.

### DETAILED DESCRIPTION OF THE PREFERRED EMBODIMENTS

The embodiments of an information processing apparatus, a method for controlling the information processing apparatus and a program according to the present invention will be explained with reference to the drawings.

### First Embodiment

First, a construction of the first embodiment will be explained.

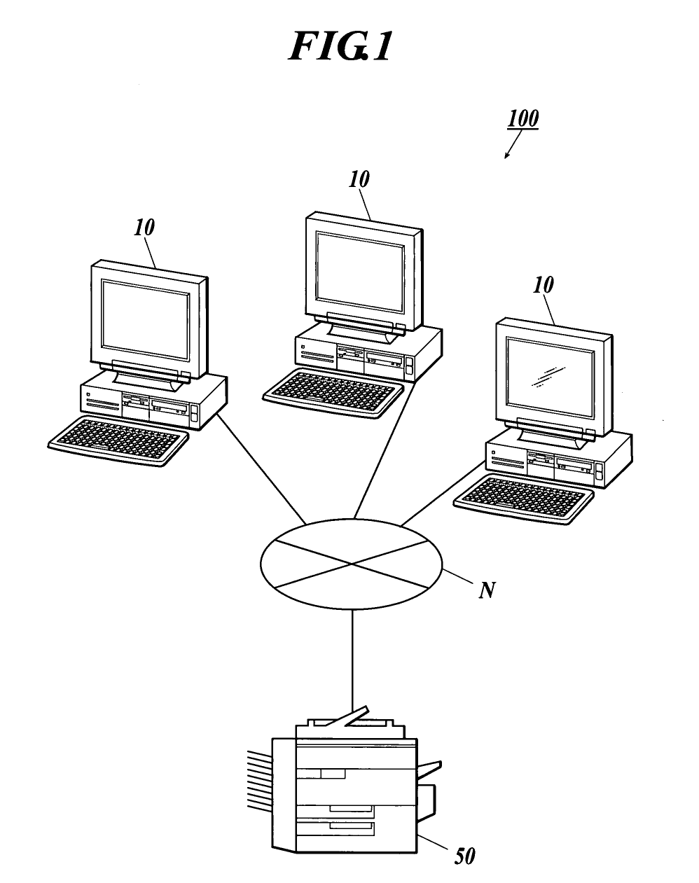

FIG. 1 is a view showing an output system 100.

As shown in FIG. 1, the output system 100 comprises user terminals 10 and a multi-functional peripheral (MFP) 50 as the information processing apparatus according to the present invention. The user terminals 10 and the MFP 50 are connected to each other through a network N such as a LAN or the Internet. Note that, although FIG. 1 shows an example in which three user terminals 10 are connected to one MFP 50, the number of user terminals 10 and that of MFPs 50 are not particularly limited.

Hereinafter, each apparatus will be explained.

The user terminals 10 are remote operation apparatuses which can remotely operate the MFP 50 by substantially the same operation interface as that of the MFP 50. Here, the remote operation refers to an operation input for instructing or setting the MFP 50 not through a main operation unit provided on the MFP 50 but through the user terminals 10 in the case of using functions of the MFP 50, such as a printing function, a copy function, a FAX function or the like. As the user terminals 10, computer apparatuses such as personal computers (PC) to be used by users are applicable.

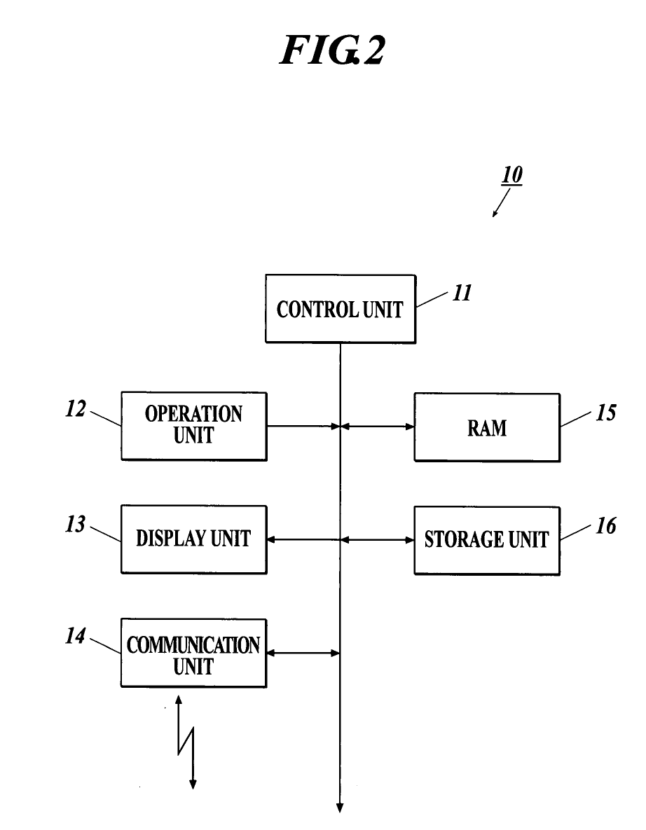

FIG. 2 shows an internal construction of each of the user terminals 10.

As shown in FIG. 2, the user terminal 10 comprises a control unit 11, an operation unit 12, a display unit 13, a communication unit 14, a random access memory (RAM) 15, and a storage unit 16.

The control unit 11 comprises a central processing unit (CPU) and the like. The control unit 11 reads out various types of control programs stored in the storage unit 16, and expands the programs in the RAM 15. Then, the control unit 11 performs various calculations or controls operations of the respective units 12 to 16 in a centralization manner in corporation with the control programs. For example, the control unit 11 performs a display control for a Web page on the display unit 13, and the like, in cooperation with a program relating to a Web browser.

The operation unit 12 comprises a mouse, a keyboard, and the like. The operation unit 12 generates operation signals corresponding to operations of these devices, and outputs the operation signals to the control unit 11.

The display unit 13 comprises a display such as a liquid crystal display (LCD), and displays various types of visual information on the display in accordance with a display control of the control unit 11. For example, the display unit 13 displays an operation screen page, a notification screen page, and the like which relate to the remote operation for the MFP 50, and constructs the operation interface.

The communication unit 14 comprises communication interfaces such as a network interface card (hereinafter referred to as an NIC), and communicates with an external instrument on the network N through the communication interfaces. For example, in accordance with a communication control of the control unit 11, the communication unit 14 transmits request information for requesting the MFP 50 to receive the operation input, user information regarding the user who performs the operation request, and the like, to the MFP 50, and receives an operation screen page for the remote operation from the MFP 50.

The RAM 15 is a work memory to be used by the control unit 11.

The storage unit 16 stores various types of control programs, and parameters, data, and the like, which are necessary to execute the programs. Moreover, the storage unit 16 stores processed data, such as text data and image data, created in the control unit 11 in cooperation with programs for word processing and image drawing.

Next, the MFP 50 will be explained.

The MFP 50 is the information processing apparatus that has a plurality of functions of printing, copying, scanning, FAX communication, and the like, and performs information processing corresponding to these functions.

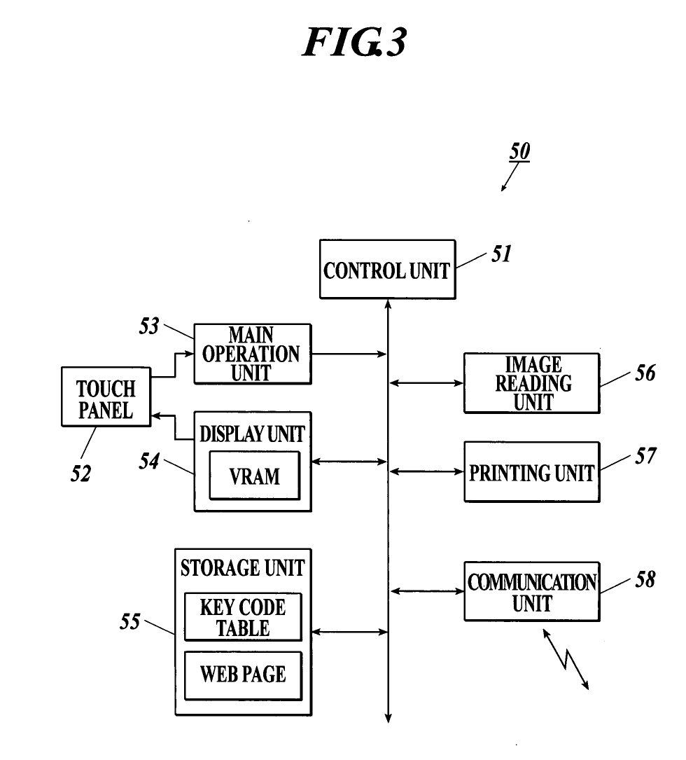

FIG. 3 shows an internal construction of the MFP 50.

As shown in FIG. 3, the MFP 50 comprises a control unit 51, a touch panel 52, a main operation unit 53, a display unit 54, a storage unit 55, an image reading unit 56, a printing unit 57, and a communication unit 58.

The control unit 51 comprises a CPU, a RAM, and the like. In accordance with various types of control programs stored in the storage unit 55, the control unit 51 performs various calculations or controls operations of each of the units 52 to 58 in a centralization manner. For example, the control unit 51 creates a Web page relating to the remote operation in cooperation with a program for a Web server, provides the Web page to the user terminals 10, and the like. The control unit 51 functions as a Web server.

The control unit 51 receives inputs through the communication unit 58 from the user terminals 10 or directly from the main operation unit 53, to receive operation requests from a plurality of users. Moreover, the control unit 51 creates operation screen data relating to the operation inputs, and displays the operation screen data on the touch panel 52. Alternatively, the control unit 52 creates Web pages relating to the operation inputs, such as the operation screen page for the remote operation, a notification screen page relating to the operation inputs, an error screen page and the like, and transmits the created Web pages to each of the user terminals 10 through the communication unit 58. In such a way, the control unit 51 provides the communication interfaces relating to the operation inputs to each of the user terminals 10.

The main operation unit 53 comprises various operation keys provided on a surface of the MFP, such as number keys and a start key for instructing starts of various functional operations including the printing, the scanning, the FAX communication, and the like. Besides the above, the main operation unit 53 comprises the touch panel 52 composed integrally with the display unit 54. The main operation unit 53 generates operation signals corresponding to pressing operations for the operation keys or to pressed positions of the touch panel 52, and outputs the operation signals to the control unit 51.

The display unit 54 comprises a video RAM (VRAM), and displays various operation screens on the touch panel 52 in accordance with the operation screen data written into the VRAM by the control unit 51. In some cases, the data written into the VRAM is hereinafter referred to as VRAM data.

The storage unit 55 stores various types of control programs, and parameters, data, and the like, which are necessary to execute the programs.

For example, the storage unit 55 stores a key code table in which operation contents corresponding to the operation keys are encoded, formats of the Web pages prepared for the remote operations, and the like.

Moreover, the storage unit 55 stores an authentication table required to authenticate users who have logged in the MFP 50. In the authentication table, user names of users permitted to perform the login in advance, user IDs and passwords, which are set for the users, and the like are stored. Note that, in the case of restricting the logins, flag information indicating that the logins are inhibited, is stored so as to relate to user information regarding the users inhibited from the logins. It can be determined whether each user is permitted to perform the login or not by referring to the flag information in the control unit 51.

The image reading unit 56 reads an image on a surface of an original document, and generates image data thereof. The image reading unit 56 comprises a mirror unit in which a light source for irradiating the original document to be read and a mirror for guiding a traveling direction of reflected light from the original to an imaging device side are integrally composed, and comprises an imaging device such as a charge coupled device (CCD) image sensor.

In the case of the reading, the original document is irradiated by allowing the mirror unit to scan the original document, an image pickup device receives the reflected light from the original document, and carries out the photoelectric conversion. An (analog) image signal generated by the photoelectric conversion is converted from analog to digital in a signal processing unit (not shown), and is stored in an image memory of the printing unit 57.

The printing unit 57 comprises a printer engine, the image memory, a sheet feeder, and the like. In accordance with a printing control by the control unit 51, the printing unit 57 prints and outputs the image by the printer engine based on object data stored in the image memory. Note that a printing method may be an electrophotographic method or an inkjet method.

The communication unit 58 comprises the communication interfaces such as the NIC and a FAX modem, and carries out data communication or FAX communication with the external instrument on the network N through the interface.

Next, the operations carried out when the output system 100 described above is remotely operated, will be explained.

In order to remotely operate the MFP 50 from each of the user terminals 10, first, it is necessary to access a Web page provided by the MFP 50 and dedicated for the remote control, and to perform a login operation. The MFP 50 transmits an input screen page for the login in response to the access from the user terminal 10. The input screen page is one for inputting the user information regarding the user who performs the remote operation request, such as the user name and password of the user who perform the login. In the user terminal 10, when the user information is inputted through the input screen page, IP address information of the user terminal 10 is added to the user information. Moreover, request information relating to the remote operation request is generated in the user terminal 10, and the user information is transmitted to the MFP 50 together with the request information.

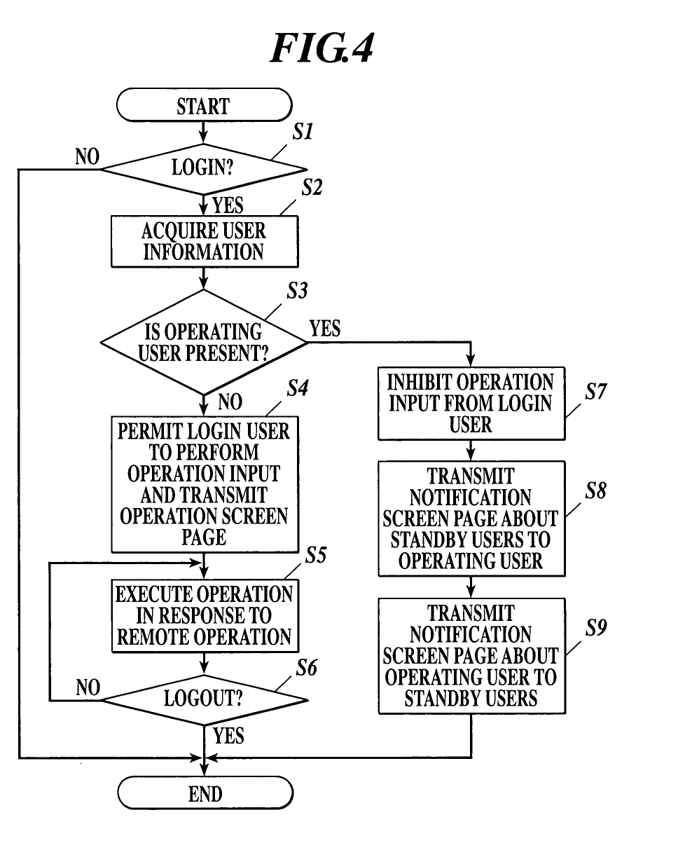

In the MFP 50, when the request information relating to the remote operation and the user information is inputted through the communication unit 58 from any of the user terminals 10, remote control processing shown in FIG. 4 is started. Hereinafter, the remote control processing will be explained with reference to FIG. 4.

In the MFP 50, when the control unit 51 determines that the operation request is inputted from any of the user terminals 10 through the input screen page, and that the login is performed (Step S1: Y), the user information regarding the user who performs the operation request is acquired (Step S2), and the user authentication is performed. The user who performed the operation request by the login is hereinafter referred to as a login user.

The user authentication is performed by collating the authentication table stored in the storage unit 55 and the acquired user information with each other. Only when the user who performs the operation request coincides with the information regarding the user permitted to perform the login in the authentication table, the user is permitted to perform the login. Then, the operations proceed to the processing of Step S2.

When the login restriction is provided, it is determined whether the user is permitted to perform the login or not after the user authentication. Then, only when the user is permitted to perform the login, the operations proceed to the processing of Step S2.

Note that, in the control unit 51, in order to manage a plurality of the login users whose operation requests are received, a management table 511 as shown in FIG. 5 is created and held in the RAM in the control unit 51. In the management table 511 shown in FIG. 5, the user information regarding the user permitted to perform the operation input and currently using the MFP 50 and the user information regarding the login user are individually stored. Here, an example in which the user names (for example, “user A” and the like) and the IP addresses (for example, “102.168.0.100”) are stored as the user information, is shown. However, the other information such as the user Ids may be stored.

When the operation request is received, in the control unit 51, the management table 511 is referred, and it is determined whether the operating user currently using the MFP 50 is present or not (Step S3). When it is determined that the user information regarding the operating user is not stored in the management table 511, and that the operating user is not present (Step S3: N), the operations proceed to processing of Step S4. Meanwhile, when it is determined that the user information regarding the operating user is stored in the management table 511, and that the operating user is present (Step S3: Y), the operations proceed to processing of Step S7.

First, the case in which the operating user is not present will be explained.

In this case, in the control unit 51, the login user who performs the operation request is permitted to use the MFP 50, and the operation screen page for the remote operation is created and transmitted to the user terminal 10 of the login user (Step S4). At this time, in the control unit 51, the acquired user information about the login user is written into columns of the operating user of the management table 511. In such a way, the login user is treated as the operating user.

In case of the operation screen page, the page having the same construction as that of the operation screen displayed on the touch panel 52 of the MFP 50 is created. The control unit 51 first acquires the VRAM data of the operation screen from the display unit 54, and converts the VRAM data into data of the portable network graphics (PNG) format. Note that the operation screen may be converted into an image in accordance with the other data format such as the BMP format and the JPEG format. Subsequently, when the PNG image data is incorporated as a clickable map into a format of the Web page prepared for the remote operation in advance, the operation screen page is completed. In the user terminal 10, the operation screen page is displayed by means of a Web browser function.

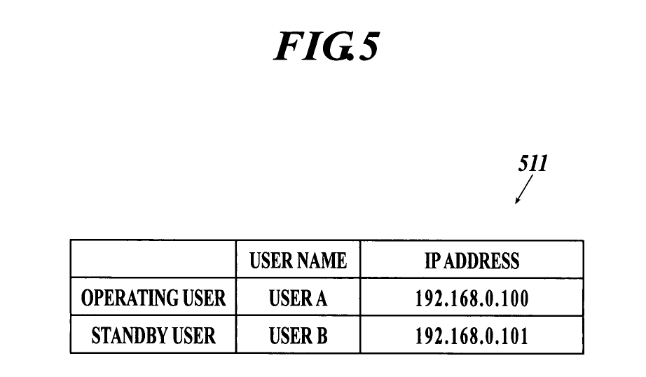

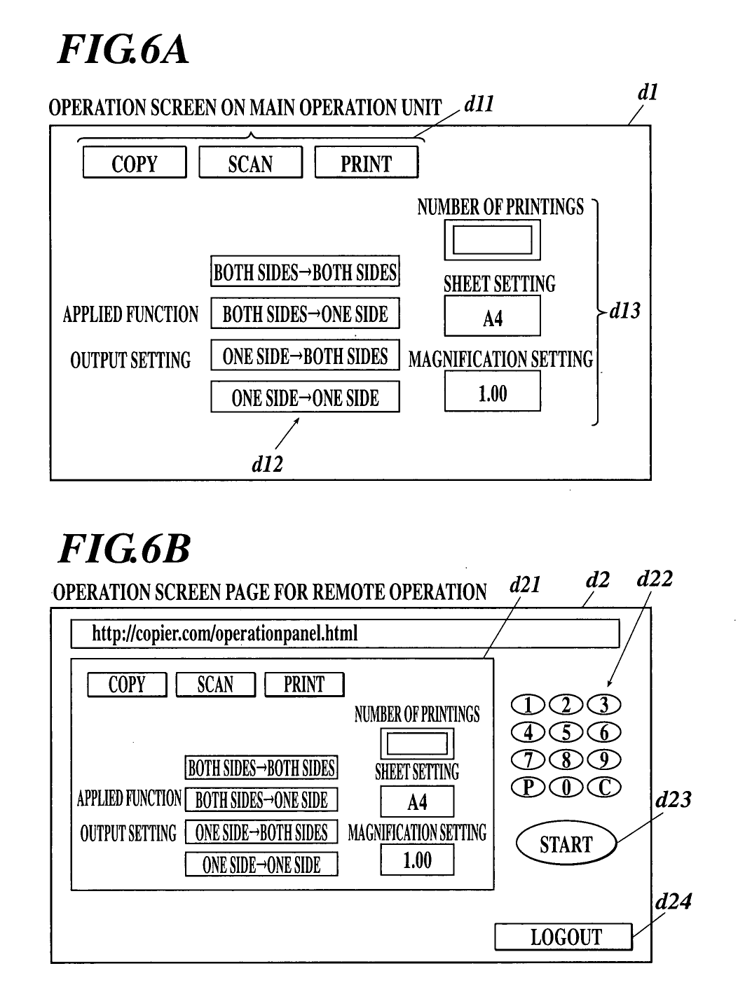

FIGS. 6A and 6B show display examples of the operation screen.

FIG. 6A is a view showing an operation screen d1 displayed on the touch panel 52 of the main operation unit 53, and FIG. 6B is a view showing an operation screen page d2 displayed on the user terminal 10.

On the operation screen d1 shown in FIG. 6A, there are displayed selection keys d11 for selecting functions such as copying, scanning, and printing and selection keys d12 and d13 for both sides/one side printing conditions, the number of printings, a sheet size and the like.

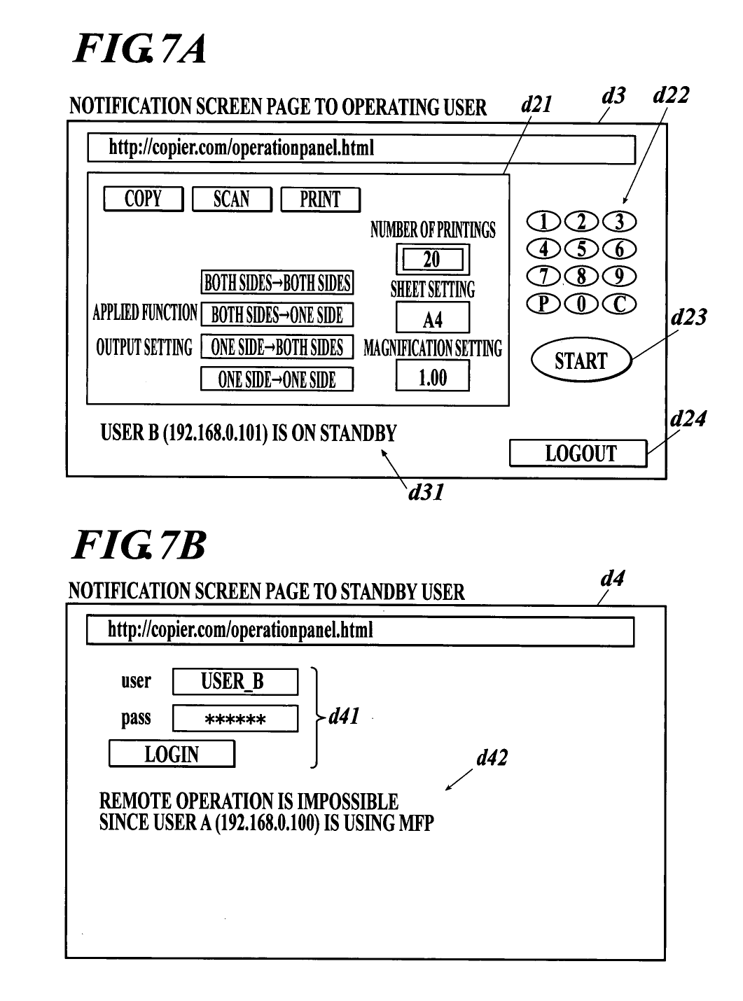

Meanwhile, on the operation screen page d2 shown in FIG. 6B, a PNG image d21 having the same contents as those of an operation screen d1 shown in FIG. 7A is displayed, and number keys d22 and a start key d23 are displayed. The number keys d22 and the start key d23 are described according to the HTML format. The number keys d22 and the start key d23 are not keys displayed on the touch panel 52, but the ones in which exterior appearances of the number keys and the start key provided on a main body of the MFP 50, are expressed by an image. Therefore, an exterior appearance of the entirety of the operation interfaces of the MFP 50, which includes the touch panel 52 and the main operation unit 53, becomes substantially the same as an appearance of the display screen constructing the operation interfaces for the remote operation in the user terminal 10.

In the user terminal 10, a position of an area where a key operation has been performed on the operation screen page d2 is specified by the control unit 11, and information regarding the position is transmitted as remote operation information to the MFP 50.

In the MFP 50, operations corresponding to the remote operation information transmitted from the user terminal 10 of the operating user through the operation screen page d2, is executed (Step S5). First, in the control unit 51, the VRAM data of the operation screen is acquired from the display unit 54. In the VRAM data, key codes are assigned to display areas of the various keys. Accordingly, based on information regarding an operation position, which is contained in the remote operation information, in the control unit 51, an area corresponding to the operation position is specified in the VRAM data. Therefore, it is possible to determine the key code of the remotely operated key. Then, operation contents corresponding to the key codes are specified based on the key code table stored in the storage unit 55, and operations corresponding to the operation contents are executed.

The operations according to the remote operation are continued until a logout key d24 on the operation screen page d2 is remotely operated in the user terminal 10 (Step S6: N). When the logout key d24 is remotely operated, in the control unit 51, the user information is deleted from the columns of the operating user in the management table 511 (Step S6: Y), and the processing is ended.

Next, the case in which the operating user is present in Step S3 will be explained.

In this case, the control unit 51 performs an exclusive control, and inhibits the operation input of the login user (Step S7). Specifically, the operation screen page d2 as shown in FIG. 6B is not transmitted to the login user, and the remote operation cannot be performed. The control unit 51 writes the user information regarding the login user into columns of a standby user of the management table 511. In such a way, the login user is treated as a standby user which waits for the operation input to the MFP 50.

Subsequently, based on the management table 511, the control unit 51 creates a notification screen page for notifying the operating user of the presence of the standby user and the user information regarding the standby user, and transmits the notification screen page to the user terminal 10 of the operating user (Step S8). Meanwhile, for the standby user, the control unit 51 creates a notification screen page for notifying the standby user of the presence of the operating user and the user information regarding the operating user, and transmits the notification screen page to the user terminal 10 of the standby user (Step S9). After the transmission is ended, this processing is ended.

The notification screen pages individually received from the MFP 50 are displayed on the user terminals 10 of the operating user and the standby user.

FIGS. 7A and 7B show examples of the notification screen pages.

FIG. 7A shows a notification screen page d3 transmitted to the operating user, and FIG. 7B shows a notification screen page d4 transmitted to the standby user.

As shown in FIG. 7A, on the notification screen page d3 for the operating user, a PNG image d21, number keys d22 and the like, which are the same as those of the operation screen page d2, and a message d31 for notifying the operating user of the presence of the standby user (for example, “User B is on standby”), the user name (for example, “User B”), and the IP address (for example, “192.168.0.101”) of the user terminal 10 which is operated by the standby user, are displayed.

Meanwhile, as shown in FIG. 7B, on the notification screen page d4 for the standby user, display contents d41 of the input screen page for the user information such as the user name and the password, and a message d42 for notifying the standby user that the remote operation is impossible (for example, “User A is now using . . . ”) since the operating user is present and for notifying the standby user of the user information such as the user name (for example, “User A”) of the operating user and the IP address (for example, “192.168.0.100”) of the user terminal 10 which is operated by the operating user, are displayed.

By displaying the notification screen pages d3 and d4 as described above, the operating user can recognize that the standby user is present. As a result, it is possible to take actions, for example, to postpone work of which importance is low and to hand over the right to use the MFP 50. Meanwhile, the standby user can recognize that the reason why the remote operation is impossible is that the operating user is present. Moreover, since the standby user can specify the operating user based on the user information regarding the operating user, it becomes possible for the standby user to take actions, for example, to request the operating user to give the right of use in the case of emergency.

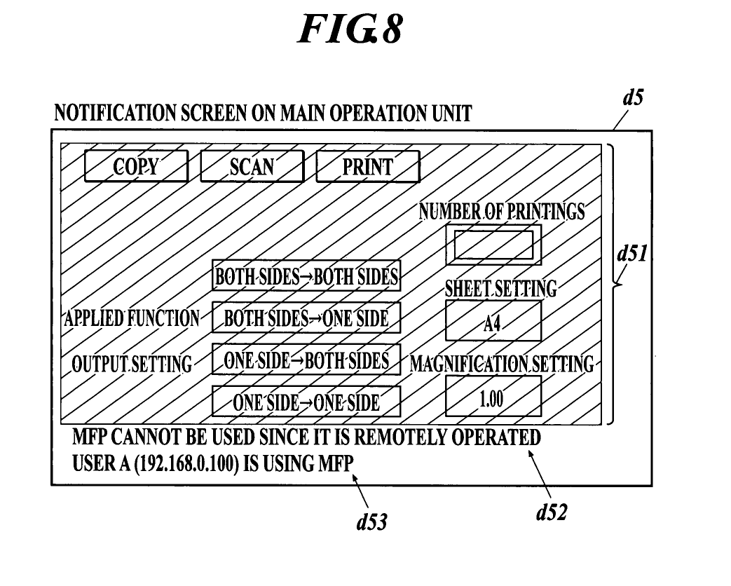

Note that, in the case that the operating user is present, also when the login operation is performed not from the user terminal 10 but from the main operation unit 53, the user which uses the main operation unit 53 is treated as the standby user, and the same processing is performed. In this case, data of a notification screen d5 as shown in FIG. 8 is created in the control unit 51, and is displayed on the touch panel 52. On the notification screen d5, since the remote operation is being performed, the operation input from the main operation unit 53 is inhibited, and a message d52 that the MFP 50 cannot be used, is displayed. Moreover, like the notification screen page shown in FIG. 7B, a message d53 for notifying the standby user of the presence of the operating user and for indicating the user information, is displayed.

As described above, according to the first embodiment, the operation requests are received from the plurality of users through the user terminals 10 (or through the main operation unit 53). Then, in the case that the operating user is present when the operation requests are received, the control unit 51 inhibits the operation inputs of the login users, and performs the exclusive control. Then, the notification screen page for notifying the login user of the presence of the operating user and the user information regarding the operating user is transmitted to the user terminals 10 of the login users (alternatively, the notification screen data is created and displayed on the touch panel 52). Hence, the login users inhibited from the operation inputs by the exclusive control can grasp a current usage situation of the MFP 50, and can specify the user who uses the MFP 50.

Moreover, the notification screen page for notifying the operating user of the presence of the login users prohibited from the operation inputs, that is, the standby users which wait for the operation inputs, and the user information regarding the standby users, is transmitted to the user terminal 10 of the operating user (alternatively, the notification screen data is created and displayed on the touch panel 52). Hence, the operating user can grasp the presence of the standby users which wait for the operation inputs to the MFP 50, and can specify the standby users.

As described above, even though the operation inputs by a plurality of users overlap one another, the operating user and the standby users are prompted to take some actions by the notification. By the actions taken by each user, the operation inputs by a plurality of users can be carried out smoothly, and as a result, it becomes possible to achieve enhancement of usage efficiency of the MFP 50.

### Second Embodiment

A second embodiment is constructed to allow each standby user to reserve the next operation input when the operating user is present in the first embodiment.

The construction of the output system according to the second embodiment is the same as that of the output system 100 of the first embodiment, and the output system according to the second embodiment is different from the output system 100 according to the first embodiment only in the operation. Hence, the same reference numerals as those in the first embodiment are assigned to the same unit of the output system of the second embodiment, a detailed description of the unit will be omitted. The characteristic operations of the second embodiment will be explained.

Like the first embodiment, also in the output system 100 in the second embodiment, login operations are necessary in the case of remotely operating the MFP 50 from the user terminals 10. Each login operation is the same as that of the first embodiment, and accordingly, a description thereof will be omitted.

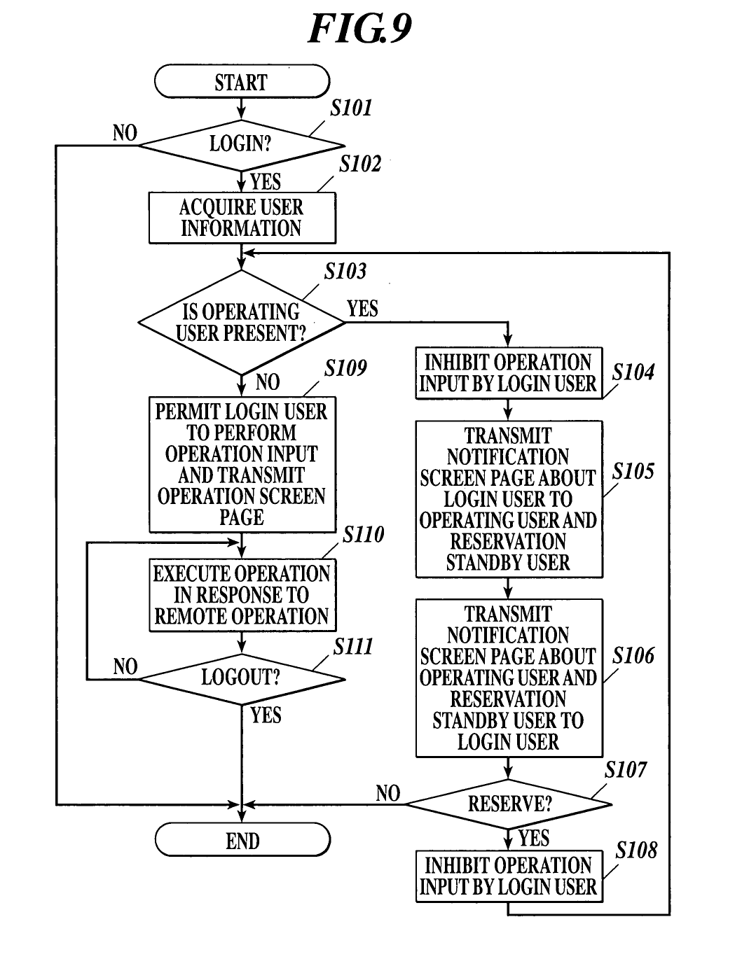

In the MFP 50, when the request information relating to the remote operation and the user information regarding the login user are inputted from any of the user terminals 10 through the communication unit 58, the control unit 51 starts reservation control processing. Hereinafter, the reservation control processing will be explained with reference to FIG. 9.

In the MFP 50, when the control unit 51 determines that the operation request is received from any of the user terminals 10, and that the login is performed (Step S101: Y), the user information regarding the login user who performs the operation request is acquired (Step S102).

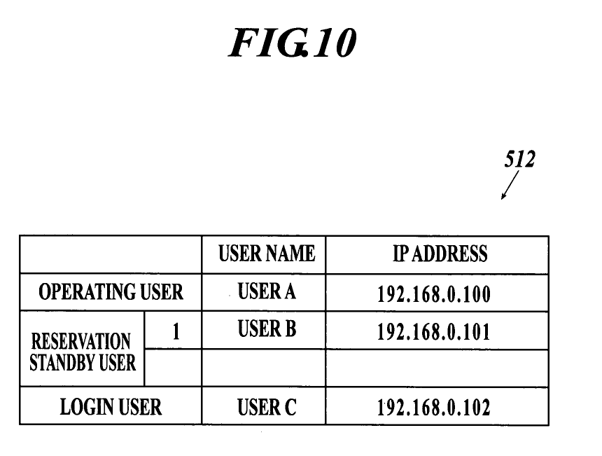

In the second embodiment, in order to manage the users whose operation requests are received in the control unit 51, a management table 512 as shown in FIG. 10 is created and held in the RAM in the control unit 51. As shown in FIG. 10, in the management table 512, columns of the operating user, the reservation standby users, and the login user are provided, and the user information (user names, IP addresses, and the like) regarding each user is stored. Note that the management table 512 is constructed to be capable of storing a plurality of pieces of the user information regarding the reservation standby users in a standby order.

In the control unit 51, the management table 512 is referred, and it is determined whether the operating user currently using the MFP 50 is present or not (Step S103). When it is determined that the user information is stored in the columns of the operating user in the management table 512, and that the operating user is present (Step S103: Y), the operations proceed to processing of Step S104. Meanwhile, when the user information regarding the operating user is not stored in the management table 512, and the operating user is not present (Step S103: N), the operations proceed to processing of Step S109.

First, the case in which the operating user is present will be explained.

In this case, the control unit 51 performs the exclusive control, and inhibits the operation input by the login user who performs the operation request (Step S104). Specifically, the operation screen page for the remote operation is not transmitted to the user terminal 10 of the login user who performs the operation request, and the remote operation cannot be performed. At this time, the control unit 51 writes the user information acquired about the login user into the columns of the login user of the management table 512.

Based on the management table 512, the control unit 51 creates the notification screen page for notifying the operating user and the reservation standby user of the presence of the login user and the user information regarding the login user, and transmits the notification screen page to the user terminals 10 of the operating user and the reservation standby user through the communication unit 58 (Step S105). Meanwhile, the control unit 51 creates the notification screen page for notifying the login user of the presence of the operating user and the standby user and the user information regarding these users, and transmits the notification screen page to the user terminal 10 of the login user (Step S106).

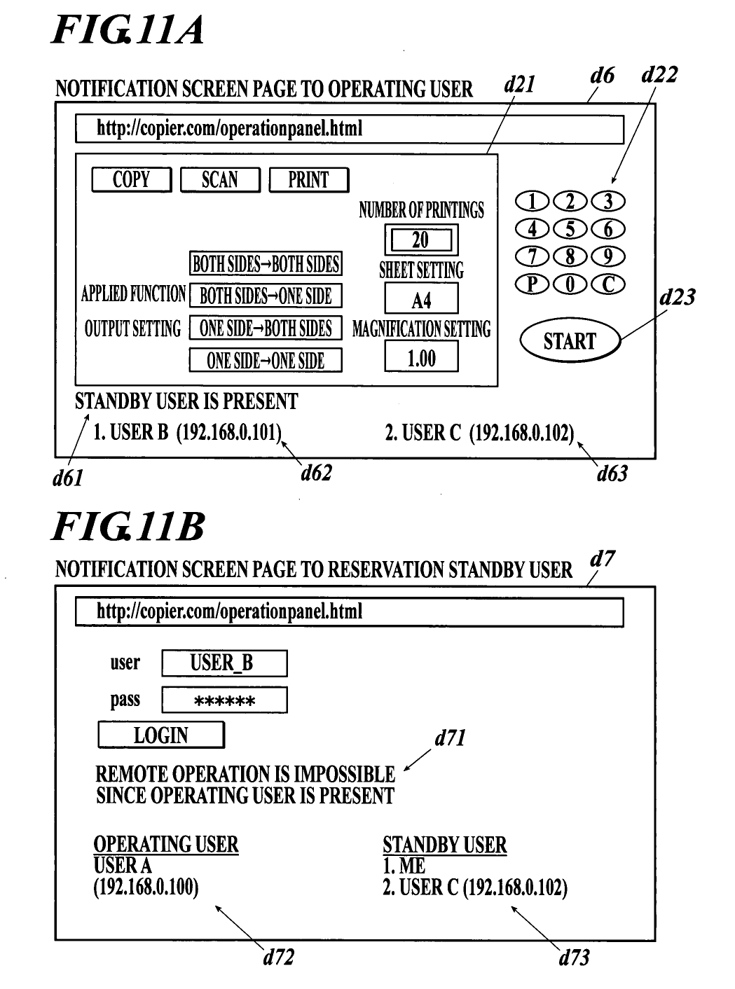

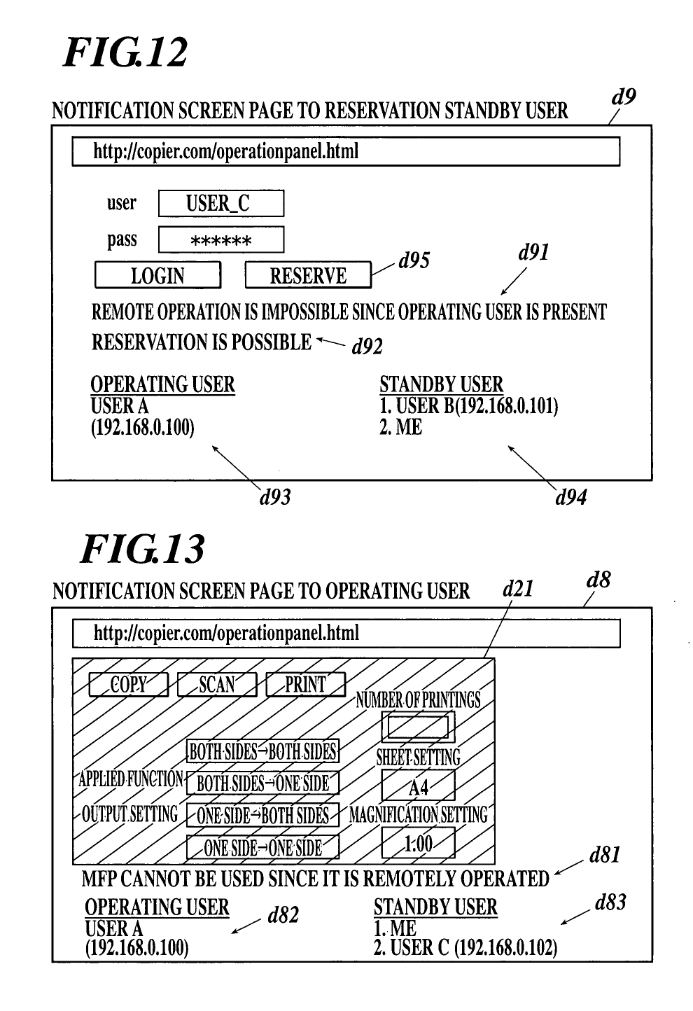

FIGS. 11A and 11B and FIG. 12 show examples of the notification screen pages.

FIG. 11A shows a notification screen page d6 transmitted to the operating user, and FIG. 11B shows a notification screen page d7 transmitted to the standby user. Moreover, FIG. 12 shows a notification screen page d9 transmitted to the login user. Here, it is assumed that, among users A, B, and C, the user A is the operating user, the user B is the reservation standby user, and the user C is the login user and the notification screen pages are explained.

As shown in FIG. 11A, on the notification screen page d6 for the operating user, display contents of the operation screen page, such as the PNG image d21 formed by converting the operation screen data displayed on the touch panel 52 of the main operation unit 53, the number keys d22, the start key d23a and the like and a message d61 indicating that the standby user is present, are displayed. Moreover, on the notification screen page d6, user information (user names and IP addresses) regarding the reservation standby user (user B) and the login user (user C) is displayed as the standby users which wait for the operation inputs to the MFP 50 in an order of the login operations.

Meanwhile, as shown in FIG. 11B, on the notification screen page d7 for the reservation standby user, a message d71 that the remote operation is impossible since the operating user is present and user information (user name and IP address) d72 is displayed. Moreover, similarly to FIG. 11A, on the notification screen page d7, user information 73d (user names and IP addresses) regarding the reservation standby user and the login user, is displayed as the standby users in an order of the login operations. At this time, the user name of the reservation standby user himself is displayed as “me”, and the display of the IP address thereof is omitted.

Meanwhile, as shown in FIG. 12, on the notification screen page d9, a message d91 that the remote operation is impossible since the operating user is present, and a message d92 that the reservation is possible, are displayed. Moreover, like the notification screen page d7 for the reservation standby user, on the notification screen page d9, user information d93 regarding the operating user, and user information d94 regarding the reservation standby user and the login user who are the standby users, are displayed. Here, the user name of the login user himself is displayed as “me”, and the display of the IP address thereof is omitted.

A reservation key 95 is provided on the notification screen page d9. The reservation key d95 is a key to be pressed in the case of reserving the next operation input to the MFP 50.

Note that, also when the login operation is performed not from the user terminal 10 but from the main operation unit 53, the same processing is performed. A notification screen which is the same as the notification screen page d6, d7 or d9 is displayed on the touch panel 52 depending on whom the user who performs the login operation is the operating user, the reservation standby user, or the login user. As an example, FIG. 13 shows the notification screen when the user is treated as the reservation standby user. Since the remote operation is being performed, the operation input from the main operation unit 53 is inhibited. On a notification screen d8, a message d81 that the MFP 50 cannot be used is displayed. Moreover, in addition to the presence of the operating user, user information d82 regarding the operating user is displayed. Further, user information regarding the reservation standby user and the login user is displayed in a standby order.

Then, when the reservation key d95 is operated on the notification screen page d9 (Step S107: Y), the control unit 51 performs reservation processing (Step S108). In the reservation processing, the user information is shifted from the columns of the login user to the columns of the reservation standby user in the management table 512, and is managed. In such a way, the login user is treated as the reservation standby user.

Then, when the operation input by the operating user is ended, the reservation standby user is permitted to perform the operation input according to the standby order based on the user information written into the columns of the reservation standby user by the control unit 51. Specifically, the user information written into the columns of the reservation standby user is used as reservation information regarding the standby user who waits for the reservation of the next operation input. Meanwhile, when the reservation operation is not performed by using the reservation key d95 (Step S107: N), the control unit 51 deletes the user information from the columns of the login user in the management table 512, and this processing is ended.

Next, the case in which it is determined that the operating user is not present in Step S103, will be explained.

When the operating user is not present, or when the remote operation of the operating user is ended (Step S103: N), the control unit 51 permits the login user to perform the operation input to the MFP 50. Then, the operation screen page for the remote operation is created and transmitted to the user terminal 10 of the permitted login user (Step S109). At this time, the control unit 51 writes the user information regarding the login user permitted to perform the operation input, into the columns of the operating user of the management table 512. In such a way, the login user is treated as the operating user.

Note that, when the user information is stored in the columns of the reservation standby user in the management table 512, and the reservation standby user is present, the reservation standby user is first permitted to perform the operation input. In this case, the control unit 51 shifts the user information regarding the reservation standby user to the columns of the operating user. Accordingly, it is determined in Step S103 that the operating user is present, and then the operations proceed to the processing of Step S104.

As the contents of the operation screen page for the remote operation, as shown in FIG. 11A, the PNG image d21, the number keys d22 and the start key d23 are displayed. Accordingly, the contents are not shown in the drawings.

Like the first embodiment, in accordance with the remote operation performed by the operating user through the operation screen page, the MFP 50 executes instructed operations (Step S110). Then, when the operating user remotely performs a logout operation (Step S111: Y), these operations are ended.

As described above, according to the second embodiment, in the case that the reservation operation is performed when the exclusive control is carried out, the user information regarding the user who performs the reservation operation is managed as the reservation information in the management table 512. Then, when the operating user becomes absent, the reservation standby users who are managed in the management table 512, are permitted to perform the operation inputs in a standby order. Hence, it becomes possible for the reservation standby users to reserve the operation inputs to the MFP 50. In such a way, it is unnecessary for the users to attempt the login again. Therefore, the operability of the NFP 50 is enhanced. In addition, the operation inputs are performed in good order in the MFP 50, and accordingly, the usage efficiency of the MFP 50 is enhanced.

Moreover, like the first embodiment, the reservation standby user and the login user who are inhibited from the operation inputs, are notified of the presence of the operating user and the user information regarding the operating user. Hence, the users inhibited from the operation inputs by the exclusive control can grasp the current usage situation of the MFP 50, and can specify the operating user. Moreover, the reservation standby user is notified of the presence of the login user and the user information regarding the login user. Accordingly, the reservation standby user can grasp the presence of the user who newly performs the operation request and the user information regarding the user. Meanwhile, the login user is notified of the presence of the reservation standby user and the user information regarding the reservation standby user. Accordingly, the login user can confirm the current reservation situation. It is possible for the login user to decide whether the reservation is carried out or not by determining a degree of congestion of the MFP 50 based on the reservation situation.

Meanwhile, the operating user permitted to perform the operation input is notified of the presence of the reservation standby user and the login user who are inhibited from the operation inputs, and each of the user information regarding these users. Hence, the operating user can grasp the presence of the standby users who wait for the operation inputs to the MFP 50, and can specify the standby users. Moreover, because the standby users are displayed in a standby order, it is possible for the operating user to grasp a standby state.

The present U.S. patent application claims the priority of Japanese Patent Application No. 2006-123937 filed on Apr. 27, 2006, according to the Paris Convention, and the above Japanese Patent Application is the basis for correcting mistranslation of the present U.S. patent application.

What is claimed is:

1. An information processing apparatus, comprising:
a control unit for receiving operation requests from a plurality of users, for acquiring user information regarding the users who perform the operation requests, for permitting an operation input from one user among the plurality of users who perform the operation requests, and for inhibiting the operation inputs from the other users; and
a notification unit for outputting notification information for notifying the other users inhibited from the operation inputs, of the user information regarding the one user who is permitted to perform the operation input.

2. The information processing apparatus of claim 1, wherein the control unit receives the operation requests from an operation input unit provided in the information processing apparatus or from a remote operation apparatus connected to the information processing apparatus through a network.

3. The information processing apparatus of claim 1, wherein the control unit generates reservation information regarding one or more reservation users who wait for the operation input among the other users inhibited from the operation input, and when the operation input from the one user is ended, the control unit permits one user among the reservation users to perform the operation input based on the reservation information.

4. The information processing apparatus of claim 3, wherein the notification unit outputs notification information for notifying the one user permitted to perform the operation input or the other users inhibited from the operation input, of a reservation situation of the operation input based on the reservation information.

5. The information processing apparatus of claim 4, wherein the reservation situation is at least one or more of presence of the reservation users and user information regarding the reservation users.

6. The information processing apparatus of claim 1, wherein the information processing apparatus is an image forming apparatus for forming an image based on an instruction from the user permitted to perform the operation input.

7. An information processing apparatus, comprising:
a control unit for receiving operation requests from a plurality of users, for permitting an operation input from one user among the plurality of users whose operation requests are received, and for inhibiting the operation input from the other users; and
a notification unit for outputting notification information for notifying the one user permitted to perform the operation input, of presence of the other users inhibited from the operation input.

8. The information processing apparatus of claim 7,
wherein the control unit acquires user information regarding the users who perform the operation requests, and
the notification unit outputs notification information for notifying the one user permitted to perform the operation input, of user information regarding the other users and presence of the other users.

9. The information processing apparatus of claim 8, wherein the control unit receives the operation requests from an operation input unit provided in the information processing apparatus or from a remote operation apparatus connected to the information processing apparatus through a network.

10. The information processing apparatus of claim 8, wherein the control unit generates reservation information regarding one or more reservation users who wait for the operation input among the other users inhibited from the operation inputs, and when the operation input from the one user is ended, the control unit permits one user among the reservation users to perform the operation input based on the reservation information.

11. The information processing apparatus of claim 10, wherein the notification unit outputs notification information for notifying the one user permitted to perform the operation input or the other users inhibited from the operation input, of a reservation situation of the operation input based on the reservation information.

12. The information processing apparatus of claim 11, wherein the reservation situation is at least one or more of presence of the reservation users and user information regarding the reservation users.

13. The information processing apparatus of claim 7, wherein the information processing apparatus is an image forming apparatus for forming an image based on an instruction from the user permitted to perform the operation input.

14. A method for controlling an information processing apparatus, comprising:
receiving operation requests to the information processing apparatus from a plurality of users, and acquiring user information regarding the users who perform the operation requests;
permitting an operation input from one user among the plurality of users who perform the operation requests, and inhibiting the operation inputs from the other users; and
outputting notification information for notifying the other users inhibited from the operation inputs, of the user information regarding the one user who is permitted to perform the operation input.

15. The method of claim 14, further comprising:
generating reservation information regarding one or more reservation users who wait for the operation input among the other users inhibited from the operation input, and permitting one user among the reservation users to perform the operation input based on the reservation information when the operation input from the one user is ended.

16. A method for controlling an information processing apparatus, comprising:
receiving operation requests to the information processing apparatus from a plurality of users;
permitting an operation input from one user among the plurality of users whose operation requests are received, and inhibiting the operation input from the other users; and
outputting notification information for notifying the one user permitted to perform the operation input, of presence of the other users inhibited from the operation input.

17. The method of claim 16, further comprising:
acquiring user information regarding the users who perform the operation requests,
wherein the notification information comprises user information regarding the other users and presence of the other users.

18. The method of claim 17, further comprising:
generating reservation information regarding one or more reservation users who wait for the operation input among the other users inhibited from the operation input, and permitting one user among the reservation users to perform the operation input based on the reservation information when the operation input from the one user is ended.

19. A computer-readable recording medium recording a program for allowing a computer that controls an information processing apparatus to execute:
receiving operation requests from a plurality of users, and acquiring user information regarding the users who perform the operation requests;
permitting an operation input from one user among the plurality of users who perform the operation requests, and inhibiting the operation inputs from the other users; and
outputting notification information for notifying the other users inhibited from the operation inputs, of the user information regarding the one user who is permitted to perform the operation input.

20. A computer-readable recording medium recording a program for allowing a computer that controls an information processing apparatus to execute:
receiving operation requests to the information processing apparatus from a plurality of users;
permitting an operation input from one user among the plurality of users whose operation requests are received, and inhibiting the operation input from the other users; and
outputting notification information for notifying the one user permitted to perform the operation input, of presence of the other users inhibited from the operation input.
